(19) United States
(12) Patent Application Publication
(10) Pub. No.: US 2015/0218366 A1
(43) Pub. Date: Aug. 6, 2015

(54) FLAME-RETARDANT POLYESTER RESIN COMPOSITIONS

(71) Applicant: KANEKA CORPORATION, (US)

(72) Inventors: Shuji Taketani, Takasago-shi (JP); Noriyuki Suzuki, Settsu-shi (JP)

(73) Assignee: KANEKA CORPORATION, Osaka (JP)

(21) Appl. No.: 13/649,253

(22) Filed: Oct. 11, 2012

(51) Int. Cl. C08L 67/03

(52) U.S. Cl. CPC C08L 67/03; C08L 2201/02; C08L 2205/16; C08L 2207/04

(57) ABSTRACT

An object is to obtain a flame-retardant polyester-based resin composition that uses no halogen-based flame retardant, has high flame retardance, and is excellent in strength retention after long-term heat resistance test under high temperature. The flame-retardant polyester-based resin composition according to the present invention contains 100 parts by weight of a thermoplastic polyester-based resin (A), 5 to 80 parts by weight of an organophosphorus-based flame retardant (B) represented by the following general formula 1, and 1 to 20 parts by weight of at least one amorphous thermoplastic resin (C) selected from the group consisting of a polyetherimide resin, a polysulfone-based resin, and a polyarylate resin.

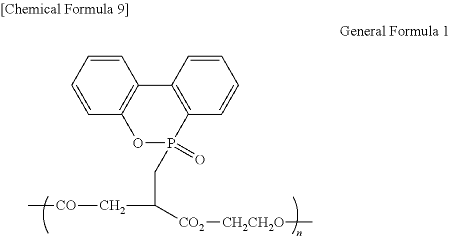

(wherein n is an integer of 2 to 40)

### TECHNICAL FIELD

The present invention relates to a flame-retardant polyester-based resin composition that uses no halogen-based flame retardant, has high flame retardance, and is excellent in strength retention after long-term heat resistance test under high temperature.

### BACKGROUND ART

Thermoplastic polyester resins typified by polyalkylene terephthalate and the like are widely used in electric and electronic parts, automotive parts, and the like due to their excellent properties. Particularly in recent years, household appliances, electric parts, and OA-related parts are often required to have high flame retardance to ensure safety against fire, and therefore mixing with various flame retardants has been studied.

Examples of a method for imparting flame retardance to a resin composition without using a halogen-based flame retardant include a method using a metal oxide and a method using a phosphorus compound. The method using a metal oxide has a problem that it is difficult to achieve desired flame-retardant characteristics unless a large amount of metal oxide is used but the use of a large amount of metal oxide deteriorates properties inherent in the resin.

As the method for imparting flame retardance to a resin using a phosphorus compound, a method using an organic (condensed) phosphate ester compound or a method using red phosphorus is conventionally known. However, an organic (condensed) phosphate ester having a relatively low molecular weight is not satisfactory in volatility, sublimability, and heat resistance, and there is a problem that when a resulting resin composition is used under high temperature for a long period of time, the flame retardant bleeds out. Further, there is a problem that such a resin composition suffers a greater deterioration in physical properties with long-term use than a system using a halogen-based flame retardant. Red phosphorus causes a problem that toxic phosphine gas is generated during drying or molding of a resulting resin composition.

Patent Documents 1 and 2 disclose techniques related to a thermoplastic resin composition containing an organophosphorus-based flame retardant having the same structure as one of components of the composition of the present application which is represented by the following general formula 1. Such a system achieves some improvement in strength retention after long-term heat resistance test under high temperature as compared to the system using an organic (condensed) phosphate ester, but is still inferior to the system using a halogen-based flame retardant, and therefore needs to be further improved.

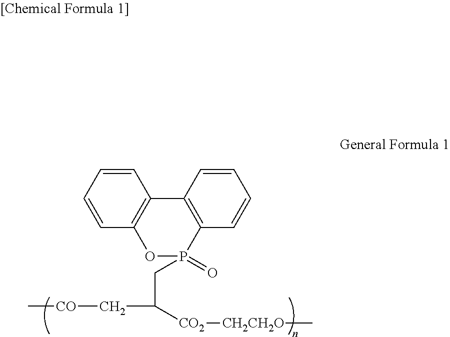

### PRIOR ART DOCUMENTS

### Patent Documents

Patent Document 1: JP 53-128195 A
Patent Document 2: WO2007/040075

### DISCLOSURE OF THE INVENTION

### Problems to be Solved by the Invention

An object of the present invention is to provide a flame-retardant polyester-based resin composition that uses no halogen-based flame retardant, has high flame retardance, and is excellent in strength retention after long-term heat resistance test under high temperature.

### Means for Solving the Problems

The present inventors have intensively studied, and as a result, have found that the above object can be achieved by blending a thermoplastic polyester-based resin with a phosphorus-based flame retardant having a specific structure and at least one amorphous thermoplastic resin (C) selected from the group consisting of a polyetherimide resin, a polysulfone-based resin such as polysulfone, polyphenylsulfone, or polyethersulfone, and a polyarylate resin, which has led to the completion of the present invention.

More specifically, the present invention relates to a flame-retardant polyester-based resin composition containing: 100 parts by weight of a thermoplastic polyester-based resin (A); 5 to 80 parts by weight of an organophosphorus-based flame retardant (B) represented by the following general formula 1; and 1 to 20 parts by weight of at least one amorphous thermoplastic resin (C) selected from the group consisting of a polyetherimide resin, a polysulfone-based resin, and a polyarylate resin.

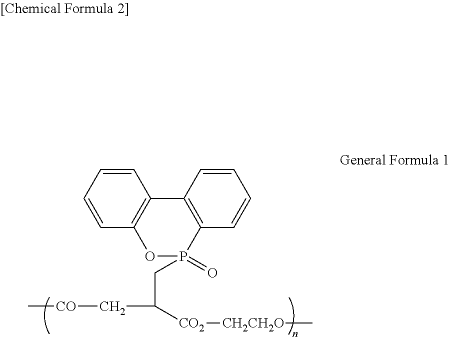

(wherein n is an integer of 2 to 40)

According to a preferred embodiment, the thermoplastic polyester-based resin (A) is polyalkylene terephthalate.

According to a preferred embodiment, the flame-retardant polyester-based resin composition further contains 5 to 120 parts by weight of an inorganic filler (D).

The present invention also relates to a molded article of the flame-retardant polyester-based resin composition.

### Effects of the Invention

The flame-retardant thermoplastic resin composition according to the present invention exhibits excellent flame retardance without using a halogen-based flame retardant and has a high retention of strength even after long-term heat resistance test under high temperature. Therefore, the flame-retardant thermoplastic resin composition is industrially useful because it is suitable for use as a molding material for household appliances, electric parts, OA equipment parts, etc. used in a heat-resistant environment.

### PREFERRED MODE FOR CARRYING OUT THE INVENTION

(Thermoplastic Polyester-Based Resin (A))

A thermoplastic polyester-based resin (A) used in the present invention refers to a saturated polyester resin obtained by using a divalent acid such as terephthalic acid or a derivative thereof having ester-forming ability as an acid component and a glycol having 2 to 10 carbon atoms, another divalent alcohol, or a derivative thereof having ester-forming ability as a glycol component. Among them, a polyalkylene terephthalate resin is preferred because it has an excellent balance of processability, mechanical properties, electric properties, heat resistance etc. Specific examples of the polyalkylene terephthalate resin include a polyethylene terephthalate resin, a polybutylene terephthalate resin, and a polyhexamethylene terephthalate resin. Among them, a polyethylene terephthalate resin is particularly preferred because it has excellent heat resistance and chemical resistance.

If necessary, the thermoplastic polyester-based resin (A) used in the present invention may be copolymerized with another component in such a ratio that its physical properties are not significantly deteriorated. Examples of the component to be copolymerized include a known acid component, alcohol component and/or phenol component, and derivatives thereof having ester-forming ability.

Examples of the copolymerizable acid component include di- or higher-valent aromatic carboxylic acids having 8 to 22 carbon atoms, di- or higher-valent aliphatic carboxylic acids having 4 to 12 carbon atoms, di- or higher-valent alicyclic carboxylic acids having 8 to 15 carbon atoms, and derivatives thereof having ester-forming ability. Specific examples of the copolymerizable acid component include terephthalic acid, isophthalic acid, naphthalenedicarboxylic acid, bis(p-carbodiphenyl)methane anthracene dicarboxylic acid, 4-4′-diphenyl carboxylic acid, 1,2-bis(phenoxy)ethane-4,4′-dicarboxylic acid, sodium 5-sulfoisophthalate, adipic acid, sebacic acid, azelaic acid, dodecanedioic acid, maleic acid, trimesic acid, trimellitic acid, pyromellitic acid, 1,3-cyclohexanedicarboxylic acid, 1,4-cyclohexanedicarboxylic acid, and derivatives thereof having ester-forming ability. They may be used singly or in combination of two or more of them. Among them, terephthalic acid, isophthalic acid, and naphthalenedicarboxylic acid are preferred because resulting resins are excellent in physical properties, handleability, and ease of reaction.

Examples of the copolymerizable alcohol and/or phenol component include di- or higher-valent aliphatic alcohols having 2 to 15 carbon atoms, di- or higher-valent alicyclic alcohols having 6 to 20 carbon atoms, di- or higher-valent aromatic alcohols or phenols having 6 to 40 carbon atoms, and derivatives thereof having ester-forming ability. Specific examples of the copolymerizable alcohol and/or phenol component include: compounds such as ethylene glycol, propanediol, butanediol, hexanediol, decanediol, neopentyl glycol, cyclohexanedimethanol, cyclohexanediol, 2,2′-bis(4-hydroxyphenyl)propane, 2,2′-bis(4-hydroxycyclohexyl)propane, hydroquinone, glycerin, and pentaerythritol, and derivatives thereof having ester-forming ability; and cyclic esters such as s-caprolactone. Among them, ethylene glycol and butanediol are preferred because resulting resins are excellent in physical properties, handleability, and ease of reaction.

Further, partial copolymerization with a polyalkylene glycol unit may be performed. Specific examples of the polyoxyalkylene glycol include polyethylene glycol, polypropylene glycol, polytetramethylene glycol, random or block copolymers thereof, and modified polyoxyalkylene glycol such as an alkylene glycol (e.g., polyethylene glycol, polypropylene glycol, polytetramethylene glycol, or a random or block copolymer thereof) adduct of a bisphenol compound. Among them, a polyethylene glycol adduct of bisphenol A having a molecular weight of 500 to 2000 is preferred because thermal stability during copolymerization is excellent and the heat resistance of a molded article obtained from the resin composition according to the present invention is less likely to be deteriorated.

These thermoplastic polyester resins may be used singly or in combination of two or more of them.

A method for producing the thermoplastic polyester-based resin (A) used in the present invention may be a known polymerization method such as melt polycondensation, solid-phase polycondensation, or solution polymerization. In order to improve the color tone of the resin during polymerization, one or two or more of compounds such as phosphoric acid, phosphorous acid, hypophosphorous acid, monomethyl phosphate, dimethyl phosphate, trimethyl phosphate, methyldiethyl phosphate, triethyl phosphate, triisopropyl phosphate, tributyl phosphate, and triphenyl phosphate may be added.

Further, in order to increase the crystallinity of the obtained thermoplastic polyester-based resin, various well-known organic or inorganic crystal nucleating agents may be added singly or in combination of two or more of them during polymerization.

The intrinsic viscosity (measured at 25° C. in a 1:1 (weight ratio) mixed solution of phenol and tetrachloroethane) of the thermoplastic polyester-based resin (A) used in the present invention is preferably 0.4 to 1.2 dl/g, and more preferably 0.6 to 1.0 dl/g. If the intrinsic viscosity is less than 0.4 dl/g, mechanical strength or impact resistance tends to be reduced, and if the intrinsic viscosity exceeds 1.2 dl/g, fluidity during molding tends to be reduced.

(Organophosphorus-Based Flame Retardant (B))

An organophosphorus-based flame retardant (B) used in the present invention is represented by the following general formula 1 and contains a phosphorus atom in its molecule. The lower limit of the number of repeating units n is 2, preferably 3, and particularly preferably 5. The upper limit of the number of repeating units n is not particularly limited, but an excessive increase in molecular weight tends to have an adverse effect on dispersibility etc. Therefore, the upper limit of the number of repeating units n is 40, preferably 35, and particularly preferably 30. If n is less than 2, the crystallization of the polyester resin tends to be inhibited or the mechanical strength of the polyester resin tends to be reduced.

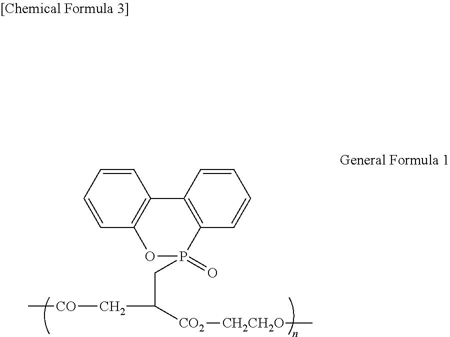

(wherein n is an integer of 2 to 40)

A method for producing the organophosphorus-based flame retardant (B) used in the present invention is not particularly limited, and may be a common polycondensation reaction. The organophosphorus-based flame retardant (B) can be obtained by, for example, the following method.

That is, 9,10-dihydro-9-oxa-10-phosphaphenanthrene-10-oxide represented by the following general formula 2 is mixed with the required amount of itaconic acid and with ethylene glycol in an amount of at least about twice as many moles as itaconic acid and heated and stirred at 120 to 200° C. under a nitrogen gas atmosphere to obtain a reaction product of 9,10-dihydro-9-oxa-10-phosphaphenanthrene-10-oxide, itaconic acid, and ethylene glycol. The obtained reaction product is mixed with antimony trioxide and zinc acetate, and the temperature is set and maintained at 245° C. under a vacuum-reduced pressure of 1 Torr or lower to perform a polycondensation reaction while ethylene glycol is distilled off. The reaction is considered completed when the amount of ethylene glycol distilled off is significantly reduced after about 5 hours. The obtained organophosphorus-based flame retardant is a solid having a molecular weight of 4000 to 12000 and a phosphorus content of 8.3%.

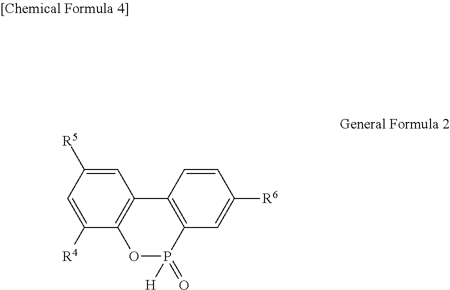

(wherein R⁴, R⁵, and R⁶ may be the same or different from one another and represent a hydrogen atom, an alkyl group, a cycloalkyl group, an aryl group, or an aralkyl group.)

The content of the organophosphorus-based flame retardant (B) needs to be 5 to 80 parts by weight with respect to 100 parts by weight of the thermoplastic polyester-based resin (A), and is preferably 10 parts by weight or more from the viewpoint of flame retardance, but is preferably 70 parts by weight or less, and more preferably 30 parts by weight or less, from the viewpoint of moldability and the mechanical strength of a molded article.

(Amorphous Thermoplastic Resin (C))

According to the present invention, the addition of at least one amorphous thermoplastic resin (C) selected from the group consisting of a polyetherimide resin, a polysulfone-based resin such as polysulfone, polyphenylsulfone, or polyethersulfone, and a polyarylate resin makes it possible to improve strength retention after long-term heat resistance test under high temperature. These resins may be used singly or in combination of two or more of them. Alternatively, a mixed product such as a polymer alloy or polymer blend with another polymer may be used. Among the above-mentioned amorphous thermoplastic resins, a polyetherimide resin is particularly preferably used from the viewpoint of electric properties.

The polyetherimide resin used in the present invention is a polymer containing, as a repeating unit, an aliphatic, alicyclic, or aromatic ether unit and a cyclic imide group, and is not particularly limited as long as it is a polymer having melt-moldability. The main chain of the polyetherimide may contain a structural unit other than cyclic imide and ether bonds, such as an aromatic, aliphatic, or alicyclic ester unit or an oxycarbonyl unit, as long as the effects of the present invention are not impaired. In the present invention, from the viewpoints of melt-moldability and cost, a condensation product of 2,2-bis[4-(2,3-dicarboxyphenoxy)phenyl]propane dianhydride and m-phenylenediamine or p-phenylenediamine (e.g., “Ultem” (registered trademark) commercially available from SABIC Innovative Plastics) is preferably used.

The polysulfone-based resin used in the present invention is a thermoplastic resin having, in its main chain, an aromatic ring group and a sulfone group as a binding group for the aromatic ring group, and is generally broadly divided into polysulfone, polyethersulfone, and polyphenylsulfone.

The polysulfone resin is typified by a polymer having a structure represented by the following general formula 3. In this specification, from the viewpoints of melt-moldability and cost, “Udel” (registered trademark) commercially available from Solvay Advanced Polymers was used.

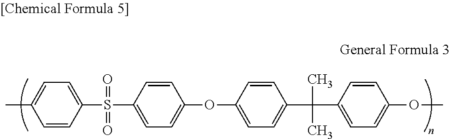

The polyethersulfone resin is obtained by the Friedel-Crafts reaction of diphenyl ether chlorosulfone and is typified by a polymer having a structure represented by the following chemical formula 4. In this specification, from the viewpoints of melt-moldability and cost, “RADEL A” (registered trademark) commercially available from Solvay Advanced Polymers was used.

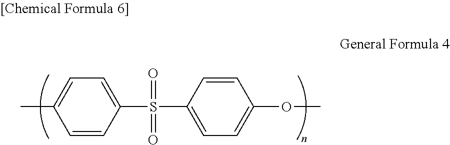

The polyphenylsulfone resin is typified by a polymer having a structure represented by the following chemical formula 5. In this specification, from the viewpoints of melt-moldability and cost, “RADEL R” (registered trademark) commercially available from Solvay Advanced Polymers was used.

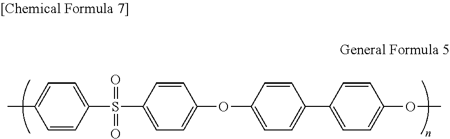

The polyarylate resin used in the present invention is a resin having, as a repeating unit, an aromatic dicarboxylic acid and a bisphenol.

Specific examples of the bisphenol include 2,2-bis(4-hydroxyphenyl)propane, 2,2-bis(4-hydroxy-3,5-dimethylphenyl)propane, 2,2-bis(4-hydroxy-3,5-dibromophenyl)propane, 2,2-bis(4-hydroxy-3,5-dichlorophenyl)propane, 4,4′-dihydroxydiphenylsulfone, 4,4′-dihydroxydiphenylether, 4,4′-dihydroxydiphenylsulfide, 4,4′-dihydroxydiphenylketone, 4,4′-dihydroxydiphenylmethane, and 1,1-bis(4-hydroxyphenyl)cyclohexane. These compounds may be used singly or in combination of two or more of them. Particularly, 2,2-bis(4-hydroxyphenyl)propane is preferred from an economical viewpoint.

Specific examples of the aromatic dicarboxylic acid include terephthalic acid, isophthalic acid, orthophthalic acid, 1,5-naphthalenedicarboxylic acid, 2,6-naphthalenedicarboxylic acid, diphenic acid, 4,4′-dicarboxydiphenyl ether, bis(p-carboxyphenyl)alkane, and 4,4′-dicarboxydiphenylsulfone. Among them, terephthalic acid and isophthalic acid are preferred.

The amount of the amorphous thermoplastic resin (C) to be added with respect to 100 parts by weight of the thermoplastic polyester-based resin (A) needs to be 1 to 20 parts by weight and is preferably 5 parts by weight or more from the viewpoint of improving strength retention after long-term heat resistance test under high temperature, but is preferably 15 parts by weight or less from the viewpoint of molding processability, that is, from the viewpoint of preventing a reduction in fluidity and from the viewpoint of preventing a reduction in the initial mechanical strength of a molded article and an increase in the cost of a product.

(Inorganic Filler)

The flame-retardant polyester-based resin composition according to the present invention may contain an inorganic filler for the purpose of improving mechanical properties, heat resistance, and strength retention after long-term heat resistance test under high temperature.

The inorganic filler used in the present invention is not particularly limited as long as it is a fibrous and/or granular inorganic filler, and the addition of the inorganic filler makes it possible to significantly improve strength, stiffness, heat resistance, etc.

Specific examples of the inorganic filler used in the present invention include glass fibers, carbon fibers, metal fibers, aramid fibers, asbestos, potassium titanate whiskers, wollastonite, glass flakes, glass beads, talc, mica, clay, calcium carbonate, barium sulfate, titanium oxide, and aluminum oxide. They may be used singly, but particularly from the viewpoint of electric properties, they are preferably used in combination of two or more of them.

The glass fibers used in the present invention may be known glass fibers in common use, but are preferably chopped strand glass fibers treated with a bundling agent from the viewpoint of workability.

In order to enhance adhesion between the resin and the glass fibers, the glass fibers used in the present invention are preferably those obtained by treating the surfaces of glass fibers with a coupling agent and may be those using a binder. Preferred examples of the coupling agent to be used include, but are not limited to, alkoxysilane compounds such as γ-aminopropyltriethoxysilane and γ-glycidoxypropyltrimethoxysilane, and preferred examples of the binder to be used include, but are not limited to, epoxy resins and urethane resins. The above-mentioned glass fibers may be used singly or in combination of two or more of them.

The glass fibers used in the present invention preferably have a fiber diameter of 1 to 20 μm and a fiber length of 0.01 to 50 mm. If the fiber diameter is less than 1 μm, there is a tendency that a desired reinforcing effect cannot be obtained, and on the other hand, if the fiber diameter exceeds 20 μm, there is a tendency that the surface nature of a molded article is impaired or fluidity is reduced. Further, if the fiber length is less than 0.01 mm, there is a tendency that a desired resin reinforcing effect cannot be obtained, and on the other hand, if the fiber length exceeds 50 mm, there is a tendency that the surface nature of a molded article is impaired or fluidity is reduced.

The lower limit of the content of the inorganic filler used in the present invention is preferably 5 parts by weight, more preferably 10 parts by weight, and even more preferably 15 parts by weight with respect to 100 parts by weight of the thermoplastic polyester-based resin (A) according to the present invention. If the lower limit of the inorganic filler content is less than 5 parts by weight, there is a case where the effect of improving heat resistance or stiffness is not satisfactory. The upper limit of the inorganic filler content is preferably 120 parts by weight, more preferably 100 parts by weight, and even more preferably 80 parts by weight. If the upper limit of the inorganic filler content exceeds 120 parts by weight, there is a case where fluidity is reduced, thin-wall moldability is impaired, or the surface nature of a molded article.

(Nitrogen Compound)

The flame-retardant polyester-based resin composition according to the present invention may contain a nitrogen compound. Combined use of the nitrogen compound and the above-described organophosphorus-based flame retardant makes it possible to further improve flame retardance. Examples of the nitrogen compound used in the present invention include a melamine-cyanuric acid adduct, a triazine-based compound such as melamine or cyanuric acid, and a tetrazole compound. Alternatively, melame and/or meleme as a dimer and/or a trimer of melamine may be used. Among them, a melamine-cyanuric acid adduct is preferred from the viewpoint of mechanical strength.

The melamine-cyanuric acid adduct used in the present invention refers to a compound formed of melamine (2,4,6-triamino-1,3,5-triazine) and cyanuric acid (2,4,6-trihydroxy-1,3,5-triazine) and/or its tautomer. The melamine-cyanuric acid adduct can be obtained by, for example, a method in which a melamine solution and a cyanuric acid solution are mixed to form a salt or a method in which one of the solutions is added to and dissolved in the other solution to form a salt. The mixing ratio between melamine and cyanuric acid is not particularly limited, but is preferably a ratio close to an equimolar ratio, and particularly preferably an equimolar ratio, because a resulting adduct is less likely to impair the thermal stability of the thermoplastic polyester resin.

The average particle diameter of the melamine-cyanuric acid adduct used in the present invention is not particularly limited, but is preferably 0.01 to 250 μm, and particularly preferably 0.5 to 200 μm, because the strength properties and molding processability of a resulting composition are not impaired.

The lower limit of the nitrogen compound content of the flame-retardant polyester resin composition according to the present invention is preferably 10 parts by weight, more preferably 20 parts by weight, and even more preferably 30 parts by weight with respect to 100 parts by weight of the thermoplastic polyester resin. If the lower limit of the nitrogen compound content is less than 10 parts by weight, flame retardance and tracking resistance tend to be reduced. The upper limit of the nitrogen compound content is preferably 100 parts by weight, and more preferably 80 parts by weight. If the upper limit of the nitrogen compound content exceeds 100 parts by weight, extrusion processability tends to be deteriorated or the strength of welds, mechanical strength, and heat and moisture resistance tend to be reduced.

(Long-Term Heat Resistance)

The time to reach 50% retention of initial tensile strength of the flame-retardant polyester-based resin composition according to the present invention after heat resistance test at 190° C. or 200° C. in accordance with ASTM D-638 (hereinafter, referred to as “half-life period”) is preferably 6000 hours or longer or 3000 hours or longer, and more preferably 7000 hours or 3500 hours, respectively. Assuming that the degradation mechanism of this material conforms to the Arrhenius's 10° C. doubling rule, if the half-life period at 190° C. or 200° C. is 6000 hours or shorter or 3000 hours or shorter, respectively, there is a high possibility that the half-life period at an actual service temperature of, for example, 150° C. is 100000 hours or shorter, which may cause a problem in practical use. It is preferred that the half-life period of electric property (dielectric breakdown strength or tracking resistance) or impact strength (Izod impact strength or tensile impact strength) at high temperature is also the same as that described above.

(Additive)

If necessary, the flame-retardant polyester-based resin composition according to the present invention may contain an antidripping agent, a pigment, a thermal stabilizer, a light stabilizer, an antioxidant, a lubricant, a plasticizer, etc.

(Production Method)

A method for producing the flame-retardant polyester-based resin composition according to the present invention is not particularly limited, and may be, for example, a method in which the thermoplastic polyester-based resin (A), the organophosphorus-based flame retardant (B), and the amorphous thermoplastic resin (C) according to the present invention are melt-kneaded using various common kneaders. Examples of the kneaders include single screw extruders and twin screw extruders, and twin screw extruders are particularly preferred because of their high kneading efficiency.

(Intended Use)

The flame-retardant polyester-based resin composition obtained in the present invention uses no halogen-based flame retardant and achieves suppression of deterioration of physical properties after long-term heat resistance test, and is therefore particularly suitable for use in household appliances, OA equipment, and the like required to have long-term heat resistance.

### EXAMPLES

Hereinbelow, the composition according to the present invention will be described more specifically with reference to specific examples, but the present invention is not limited thereto.

Resins and raw materials used in Examples and Comparative Examples are as follows.

[Polyester resin (A1)] Polyethylene terephthalate resin (manufactured by Bell Polyester Products, Inc. under the product name of EFG-70)
[Organophosphorus-based flame retardant (B1)]Organophosphorus-based flame retardant synthesized in Production Example 1
[Organophosphorus-based flame retardant (B2)] 1,3-phenylenebis(dixylenyl)phosphate (manufactured by Daihachi Chemical Industry Co., Ltd. under the product name of PX-200)
[Amorphous thermoplastic resin (C1)] Polyarylate resin (manufactured by Unitika Ltd. under the product name of U-Polymer (registered trademark) U-100)
[Amorphous thermoplastic resin (C2)] Polysulfone resin (manufactured by Solvay Advanced Polymers under the product name of Udel (registered trademark) P-1700)
[Amorphous thermoplastic resin (C3)] Polyphenylsulfone resin (manufactured by Solvay Advanced Polymers under the product name of Radel (registered trademark) R-5000)
[Amorphous thermoplastic resin (C4)] Polyetherimide resin (manufactured by SABIC Innovative Plastics under the product name of ULTEM 1000 (registered trademark))
[Amorphous thermoplastic resin (C5)] Polystyrene resin (manufactured by Toyo-Styrene Co., Ltd. under the product name of Toyo Styrol (registered trademark) GP HRM24N)
[Amorphous thermoplastic resin (C6)] Polycarbonate resin (manufactured by Idemitsu Kosan Co., Ltd. under the product name of Tarflon (registered trademark) A2200)
[Amorphous thermoplastic resin (C7)] Polyphenylene ether resin (manufactured by Mitsubishi Engineering-Plastics Corporation under the product name of Lupiace (registered trademark) PX-100L)
[Inorganic compound (D1)] Glass fibers (manufactured by Nippon Electric Glass Co., Ltd. under the product name of T-187H)
[Inorganic compound (D2)] Talc (manufactured by Nippon Talc Co., Ltd. under the product name of Rose Talc)
[Inorganic compound (D3)] Mica (manufactured by Yamaguchi Mica Co., Ltd. under the product name of A-41S)
[Nitrogen compound (E1)] Melamine cyanurate (manufactured by Nissan Chemical Industries, Ltd. under the product name of MC4000)
[Phosphorus compound (F1)] 9,10-dihydro-9-oxa-10-phosphaphenanthrene-10-oxide (manufactured by Sanko Co., Ltd. under the product name of HCA)

Evaluation methods in this specification are as follows.

<Flame Retardance>

Obtained pellets were dried at 120° C. for 3 hours and then injection-molded using an injection molding machine (JS36SS, clamp pressure: 35 tons) under conditions where a cylinder setting temperature was 250 to 280° C. and a mold temperature was 60° C. to obtain a test piece of 127 mm×12.7 mm×1.6 mm (thickness). Flammability was evaluated using the obtained bar-shaped test piece having a thickness of 1.6 mm in accordance with UL94 V-0.

<Half-Life Period of Tensile Strength>

Obtained pellets were dried at 120° C. for 3 hours and then injection-molded using an injection molding machine (IE-75E-2A manufactured by Toshiba Machine Co., Ltd. (clamp pressure: 75 tons)) under conditions where a cylinder setting temperature was 250 to 280° C., a mold temperature was 60° C., and an injection rate was 30 cm³/sec to prepare a dumbbell-shaped test piece in accordance with ASTM D-638. A tensile test was performed using the obtained measurement test piece in accordance with ASTM D-638 to measure tensile strength at 23° C. Then, a sample that had been subjected to a test in accordance with the following heat resistance test method was subjected to a tensile test in the same manner as described above, and the time to reach 50% of the tensile strength before the heat resistance test was defined as a half-life period at the temperature of the heat resistance test.

<Heat Resistance Test>

Dumbbell-shaped test pieces obtained in such a manner as described above were horizontally placed in a geer oven (GPHH-200 manufactured by Tabai) at 190 or 200° C. and taken out as samples at regular time intervals for use in the above-described tensile test after heat resistance test.

### Production Example 1

A phosphorus-containing compound (F1), 60 parts by weight of itaconic acid equimolar to (F1), and 160 parts by weight of ethylene glycol in an amount of at least twice as many moles as itaconic acid were placed in a vertical polymerization vessel equipped with a distillation tube, a rectification tube, a nitrogen inlet tube and a stirrer, and gradually heated to increase its temperature to 120 to 200° C. under a nitrogen gas atmosphere and stirred for about 10 hours. Then, 0.1 parts by weight of antimony trioxide and 0.1 parts by weight of zinc acetate were added thereto, and the temperature was maintained at 220° C. under a vacuum-reduced pressure of 1 Torr or less to perform a polycondensation reaction while ethylene glycol was distilled off. The reaction was considered completed when the amount of ethylene glycol distilled off was significantly reduced after about 5 hours.

### Examples 1 to 7

The raw materials shown in Table 1 were previously dry-blended according to formulations (unit: part by weight) shown in Table 1. Each of the dry-blended products was supplied to a vented 44 mmφ co-rotating twin screw extruder (TEX44 manufactured by The Japan Steel Works, Ltd.) through a hopper inlet, melt-kneaded at a cylinder setting temperature of 250 to 280° C. to obtain pellets, and evaluated according to the above-described evaluation methods. The evaluation results are shown in Table 1. The amorphous thermoplastic resins (C) used in Examples 1 to 7 were a polyarylate resin (Example 1), a polysulfone resin (Example 2), a polyphenylenesulfone resin (Example 3), and a polyetherimide resin (Examples 4 to 7).

TABLE 1

| | | | Examples | | | | | | |
|---|---|---|---|---|---|---|---|---|---|
| | | | 1 | 2 | 3 | 4 | 5 | 6 | 7 |
| Formulation (part) | Thermoplastic polyester resin A1 | | 100 | 100 | 100 | 100 | 100 | 100 | 100 |
| | Thermoplastic polyester resin A2 | | | | | | | | |
| | Organophosphorus-based flame | | 15 | 15 | 15 | 15 | 15 | 10 | 10 |
| | retardant (B1) | | | | | | | | |
| | Organophosphorus-based flame | | | | | | | | |
| | retardant (B2) | | | | | | | | |
| | Amorphous thermoplastic resin (C1) | | 5 | | | | | | |
| | Amorphous thermoplastic resin (C2) | | | 5 | | | | | |
| | Amorphous thermoplastic resin (C3) | | | | 5 | | | | |
| | Amorphous thermoplastic resin (C4) | | | | | 5 | 15 | 5 | 5 |
| | Amorphous thermoplastic resin (C5) | | | | | | | | |
| | Amorphous thermoplastic resin (C6) | | | | | | | | |
| | Amorphous thermoplastic resin (C7) | | | | | | | | |
| | Inorganic compound (D1) | | 90 | 90 | 90 | 90 | 90 | 87 | 74 |
| | Inorganic compound (D2) | | | | | | | 13 | 13 |
| | Inorganic compound (D3) | | | | | | | | 13 |
| | Nitrogen compound (E1) | | 20 | 20 | 20 | 20 | 20 | 28 | 28 |
| Properties | Flame retardance | | V-0 | V-0 | V-0 | V-0 | V-0 | V-0 | V-0 |
| | Long-term heat | 190° C. | >10000 | 8000 | 8400 | 6800 | 7400 | 9200 | >10000 |
| | resistance test | | | | | | | | |
| | (Half-life period of | 200° C. | 5000 | 3800 | 3400 | 4600 | 4800 | 4200 | 5600 |
| | tensile strength) | | | | | | | | |

### Comparative Examples 1 to 5

The raw materials were blended according to formulations (unit: part by weight) shown in Table 2 and pelletized and injection-molded in the same manner as in Examples 1 to 8 to obtain test pieces, and experiments were performed according to the same evaluation methods as described above. The evaluation results of Comparative Examples 1 to 4 are shown in Table 2. In Comparative Examples 1 and 2, the amorphous thermoplastic resin (C) was not used. The amorphous thermoplastic resins used in Comparative Examples 3 to 5 were a polystyrene resin (Comparative Example 3), a polycarbonate resin (Comparative Example 4), and a polyphenylene ether resin (Comparative Example 5).

TABLE 2

| | | | Comparative Examples | | | | |
|---|---|---|---|---|---|---|---|
| | | | 1 | 2 | 3 | 4 | 5 |
| Formulation (part) | Thermoplastic polyester resin A1 | | 100 | 100 | 100 | 100 | 100 |
| | Thermoplastic polyester resin A2 | | | | | | |
| | Organophosphorus-based flame retardant (B1) | | | 15 | 15 | 15 | 15 |
| | Organophosphorus-based flame retardant (B2) | | 15 | | | | |
| | Amorphous thermoplastic resin (C1) | | | | | | |
| | Amorphous thermoplastic resin (C2) | | | | | | |
| | Amorphous thermoplastic resin (C3) | | | | | | |
| | Amorphous thermoplastic resin (C4) | | | | | | |
| | Amorphous thermoplastic resin (C5) | | | | 5 | | |
| | Amorphous thermoplastic resin (C6) | | | | | 5 | |
| | Amorphous thermoplastic resin (C7) | | | | | | 5 |
| | Inorganic compound (D1) | | 90 | 90 | 90 | 90 | 90 |
| | Inorganic compound (D2) | | | | | | |
| | Inorganic compound (D3) | | | | | | |
| | Nitrogen compound (E1) | | 20 | 20 | 20 | 20 | 20 |
| Properties | Flame retardance | | V-1 | V-0 | V-1 | V-0 | V-0 |
| | Long-term heat resistance test | 190° C. | 2600 | 5000 | 3400 | 4200 | 4000 |
| | (Half-life period of tensile | 200° C. | 2000 | 2600 | 2200 | 2400 | 2000 |

strength)

As can be seen from a comparison between Examples 1 to 7 and Comparative Examples 1 to 5, a flame-retardant polyester-based resin composition that uses no halogen-based flame retardant, has high flame retardance, and is excellent in strength retention after long-term heat resistance test under high temperature can be obtained by blending a thermoplastic polyester-based resin (A) with a phosphorus-based flame retardant (B) according to the present invention having a specific structure and a specific amorphous thermoplastic resin (C) according to the present invention.

1. A flame-retardant polyester-based resin composition comprising: 100 parts by weight of a thermoplastic polyester-based resin (A); 5 to 80 parts by weight of an organophosphorus-based flame retardant (B) represented by the following general formula 1; and 1 to 20 parts by weight of at least one amorphous thermoplastic resin (C) selected from the group consisting of a polyetherimide resin, a polysulfone-based resin, and a polyarylate resin. 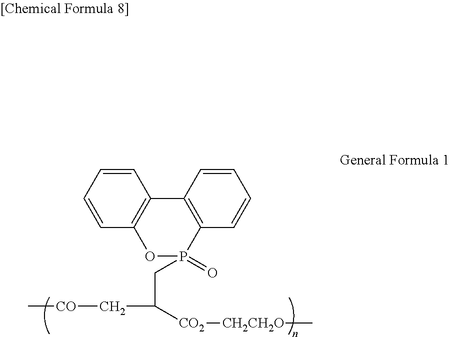
(wherein n is an integer of 2 to 40)

2. The flame-retardant polyester-based resin composition according to claim 1, wherein the thermoplastic polyester-based resin (A) is polyalkylene terephthalate.

3. The flame-retardant polyester-based resin composition according to claim 1, further comprising 5 to 120 parts by weight of an inorganic filler (D).

4. A molded article of the flame-retardant polyester-based resin composition according to claim 1.

5. The flame-retardant polyester-based resin composition according to claim 2, further comprising 5 to 120 parts by weight of an inorganic filler (D).

6. A molded article of the flame-retardant polyester-based resin composition according to claims 2.

7. A molded article of the flame-retardant polyester-based resin composition according to claim 3.
